(19) United States
(12) Patent Application Publication
(10) Pub. No.: US 2013/0091561 A1
(43) Pub. Date: Apr. 11, 2013

(54) EXECUTING COMMANDS PROVIDED DURING USER AUTHENTICATION

(71) Applicants: Keisey L. Bruso, Minneapolis, MN (US); Glen E. Newton, Eagan, MN (US); Mark G. Hazzard, Forest Lake, MN (US)

(72) Inventors: Keisey L. Bruso, Minneapolis, MN (US); Glen E. Newton, Eagan, MN (US); Mark G. Hazzard, Forest Lake, MN (US)

(21) Appl. No.: 13/271,152

(22) Filed: Oct. 11, 2011

(51) Int. Cl. G06F 21/00

(52) U.S. Cl. 726/16

(57) ABSTRACT

A mobile device may receive commands during confirmation of an identity of an individual access the device or secure data on the device. The commands may instruct the mobile device to perform security-related functions. For example, when the individual is under duress when logging in to the mobile device, the individual may perform a gesture indicating to the mobile device to change the password. The mobile device then changes the password for the individual to a secondary password. If a thief then takes the mobile device from the individual, the thief will no longer have access to the mobile device using the password provided by the individual under duress.

The instant disclosure relates to security for electronic devices. More specifically, this disclosure relates to methods for assisting an operator of an electronic device under duress.

### BACKGROUND

Data access on mobile devices is increasing at a rapid pace, but authenticating individuals on mobile devices presents new challenges. For example, individuals may have access to their bank account information from their mobile phone or laptop computer but the mobile device may be stolen or misplaced. An unauthorized individual who finds or steals the mobile device should be prevented from accessing secure data through the mobile device. There is no guarantee that the user of the mobile device is an individual authorized to view the information.

One conventional solution is to include user name and password authentication on the mobile device. This authentication technique tests an individual's knowledge and assumes that an individual with the correct user name and password is authorized to access the information. However, the user name and password combinations may be stolen if the media recording the combinations is insecure, or stolen by a hidden camera, or stolen by keystroke recording, or stolen by other social engineering techniques. Additionally, an authorized individual may forget cryptic information such as user name and password combinations.

Another conventional solution uses biometric authentication to test an individual's physical presence. For example, a fingerprint may be stored and the protected information is unavailable unless a user's fingerprint matches the fingerprint of an authorized individual. Although biometric authentication is more difficult to spoof than a username and password combination, biometric authentication is not immune to attacks. For example, a user may mimic an authorized individual's finger with gummy bear jelly placed on the attacker's finger. Additionally, in more extreme cases, an attacker may employ the severed limb exploit by detaching an authorized individual's finger. Conventional biometric authentication may produce false negatives as a result of temperature, humidity, air pressure, aging, pregnancy, injury, or illness. Similarly, when facial recognition is employed to authenticate an individual, the authentication may be spoofed by capturing an image of a photograph.

However, none of these solutions takes into consideration that even when correct authentication information, whether biometric or a username and password combination, is entered into the device, the entry may be forced from the individual under duress. For example, an individual may be under duress due to the threats or actions of an offender. In one scenario, an individual may be forced at gunpoint to access their mobile device, authenticate through the mobile device to gain access to a bank account, and transfer money to an account accessible by the offender.

### SUMMARY

According to one embodiment, a method includes requesting confirmation of identity from an individual. The method also includes receiving a confirmation response from the individual. The method further includes determining whether the confirmation response corresponds to a duress response. The method also includes activating a silent alarm when the confirmation response corresponds to the duress response.

According to another embodiment, a computer program product includes a non-transitory computer readable medium having code to request confirmation of identity from an individual. The medium also includes code to receive a confirmation response from the individual. The medium further includes code to determine whether the confirmation response corresponds to a duress response. The medium also includes code to activate a silent alarm when the confirmation response corresponds to the duress response.

According to yet another embodiment, an apparatus includes a memory, an input device, and a processor coupled to the memory and coupled to the input device. The processor is configured to request confirmation of identity from an individual. The processor is also configured to receive a confirmation response from the individual through the input device. The processor is further configured to determine whether the confirmation response corresponds to a duress response stored in the memory. The processor is also configured to activate a silent alarm when the confirmation response corresponds to the duress response.

According to a further embodiment, a method includes requesting confirmation of an identity from an individual. The method also includes receiving identity confirmation from the individual. The method further includes determining whether the identity confirmation corresponds to a command. The method also includes executing the command when the identity confirmation corresponds to the command.

According to another embodiment, a computer program product includes a non-transitory computer readable medium having code to request confirmation of an identity from an individual. The medium also includes code to receive identity confirmation from the individual. The medium further includes code to determine whether the identity confirmation corresponds to a command. The medium also includes code to execute the command when the identity confirmation corresponds to the command.

According to yet another embodiment, an apparatus includes a memory and a processor coupled to the memory. The processor is configured to request confirmation of an identity from an individual. The processor is also configured to receive identity confirmation from the individual. The processor is further configured to determine whether the identity confirmation corresponds to a command. The processor is also configured to execute the command when the identity confirmation corresponds to the command.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating an exemplary method for executing a command entered during identity confirmation according to one embodiment of the disclosure.

FIG. 2 is a flow chart illustrating an exemplary method for activating a silent alarm according to one embodiment of the disclosure.

FIG. 3 is a flow chart illustrating an exemplary method for authenticating an individual with a challenge action according to one embodiment of the disclosure.

FIGS. 4A-4B are animations illustrating exemplary gesture motions for an action challenge response according to one embodiment of the disclosure.

FIG. 5 is a call diagram illustrating activation of a silent alarm according to one embodiment of the disclosure.

FIG. 6 is a call diagram illustrating activation of a silent alarm through a server-based authentication system according to one embodiment of the disclosure.

FIG. 7 is a flow chart illustrating an exemplary method for allowing limited operation of a device in response to a silent alarm according to one embodiment of the disclosure.

FIG. 8 is a flow chart illustrating an exemplary method for presenting dummy data on a device in response to a silent alarm according to one embodiment of the disclosure.

FIG. 9 is block diagram illustrating a data management system configured to store databases, tables, and/or records according to one embodiment of the disclosure.

FIG. 10 is a block diagram illustrating a data storage system according to one embodiment of the disclosure.

FIG. 11 is a block diagram illustrating a computer system according to one embodiment of the disclosure.

### DETAILED DESCRIPTION

When an individual attempts to access an electronic device, such as a cellular phone or a tablet computer, the individual may be prompted to confirm his or her identity with the electronic device. For example, the individual may be asked to enter a username and password combination. The individual may additionally or alternatively be asked to perform a challenge action such as, for example, moving the electronic device in a particular fashion or performing an action in front of a camera of the electronic device. When the individual is prompted to confirm his or her identity, the individual may instead provide input that the device will recognize corresponding to a command for execution by the device.

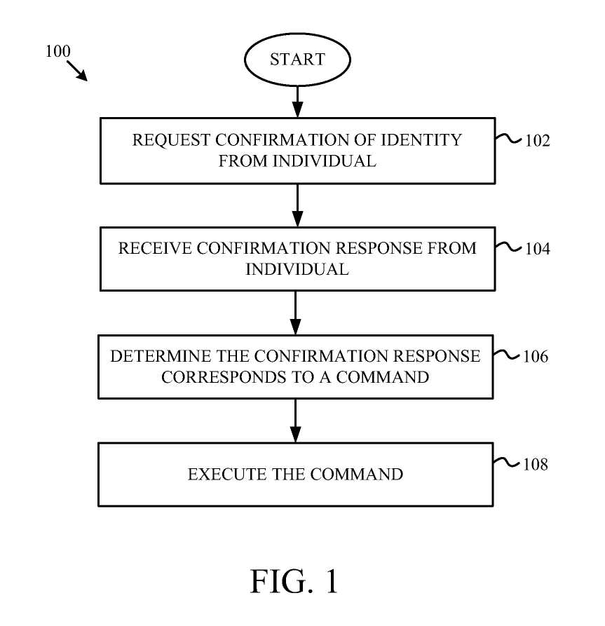

FIG. 1 is a flow chart illustrating an exemplary method for executing a command entered during identity confirmation according to one embodiment of the disclosure. A method 100 begins at block 102 with requesting confirmation of identity from an individual accessing a device. The request may include a request for authentication information and/or a request for a challenge action, described in further detail below. At block 104 a confirmation response is received from the individual. The confirmation response may include authentication information and/or an action challenge response.

At block 106 it is determined whether the received confirmation response corresponds to a command. For example, when the authentication information is a username and password combination, a certain password may correspond to a command. An individual with a username of “billsmith1” and a password of “hubner4” may enter this as authentication information as part of the confirmation response. When the device receives this confirmation response, the device may allow access to the device and/or data stored on the device. However, other passwords may be configured for the username “billsmith1,” which correspond to commands. For example, if the username “billsmith1” is entered with a password of “checkmail” the device may be instructed to check the mail for “billsmith1.” The number of received messages may be displayed on the screen with or without allowing access to the device. Similarly, the display on a device may be customized corresponding to the password entered. For example, where the password is “hubner,” entering the password as “hubner4” may instruct the device to display the fourth home screen after authenticating the individual. Although described with respect to a single individual, confirmation responses corresponding to commands for execution may be linked to multiple individuals. At block 108 the electronic device executes the command corresponding to the confirmation response. After the command is executed at block 108 the device and/or secure data may or may not become available to the individual.

In another example, a command may be issued to the device to change the authentication information. For example, if an individual observes suspicious behavior in the area while entering authentication information, the individual may follow the authentication information with an additional code or a gesture. For example, the individual may append “1xfy” onto the end of their existing valid password or the individual may make a wave gesture after entering in their password. When the device detects valid authentication information and the command, the device may grant the user access and change the authentication information to secondary or back-up authentication information, such as a second password. The next time a user attempts to access the device with the original authentication information the device will deny access to the individual. The individual must enter the secondary authentication information on the next attempt to access the device. Thus, if an offender forces an individual to grant them access to the device, the individual may instruct the device to change the valid authentication information, such that the offender is unable to access the device at a later time away from the individual.

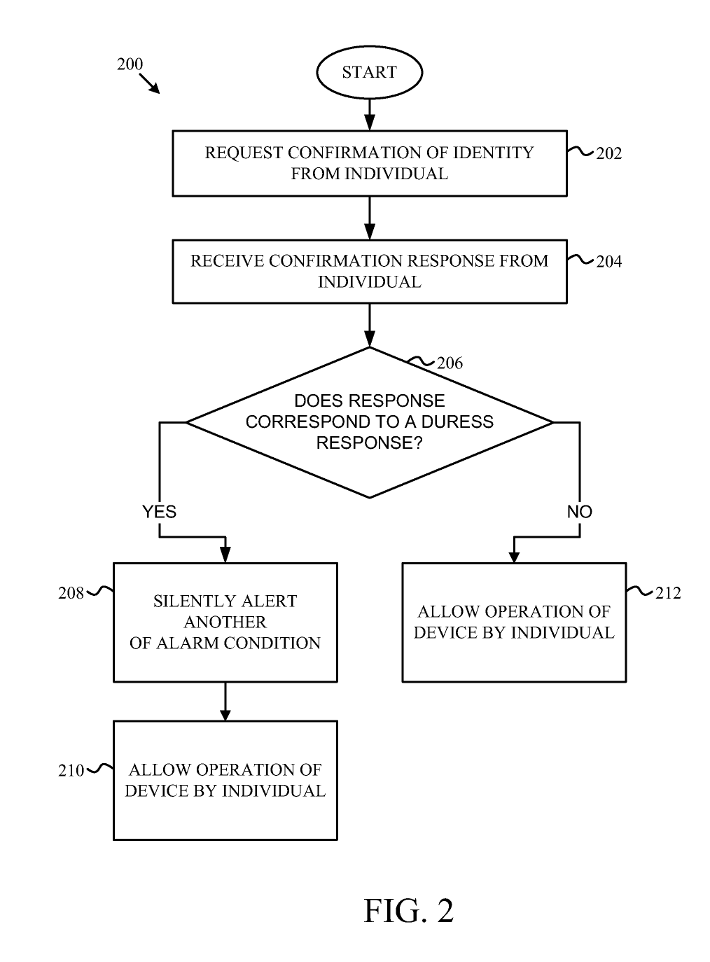

According to one embodiment, the individual may enter a password or perform a challenge action that instructs the electronic device to activate a silent alarm. FIG. 2 is a flow chart illustrating an exemplary method for activating a silent alarm according to one embodiment of the disclosure. A method 200 begins at block 202 with requesting confirmation of identity from an individual. At block 204 a confirmation response is received from the individual. At block 206 it is determined whether the received response corresponds to a duress response. That is, whether the confirmation response provided by the individual matches a previously defined response to indicate that the individual was forced to provide the confirmation response under duress. For example, if “helpme” is defined as a duress response and an individual logs in with the username “billsmith1” and password “helpme,” the method 200 proceeds to block 208 and block 210.

At block 208 another individual is silently alerted to the duress condition. For example, a message may be transmitted to local law enforcement officials notifying them that the individual is under duress. When an individual is forced at gunpoint to provide the confirmation response to unlock the device and/or gain access to secure data, the individual may enter the password “giraffe,” or another password defined on the device as a duress response, to activate the silent alarm at block 208. After the silent alarm is triggered, the method 200 continues to block 210 to allow the individual access to the device and/or secure data. According to one embodiment, after the silent alarm is activated at block 208 the device and/or secure data may remain unavailable to the individual.

The duress response may take on a number of forms depending on the type of confirmation response entered by the individual. Described above is a confirmation response having authentication information, such as a username and password combination. Security may be improved by adding additional requirements for an individual to authenticate before gaining access to secure data or a device. An additional layer of security to the authentication information described above may be a challenge action requesting the user to perform an action with the device after receiving the username/password combination. The action may be detected through one or more of the sensors embedded in the device.

According to one embodiment, the challenge action may be known only to a specific individual. Thus, even if an imposter obtains the username/password combination for an individual, the imposter will be unable to authenticate because the imposter does not know the challenge action assigned to the individual associated with the username/password combination.

According to another embodiment, the challenge action may be a random motion gesture to be performed by the individual to ensure the individual is a real person. The challenge action prevents an automated system from attempting to hack into secure data or a device, because the automated system is unable to generate a response to the challenge action.

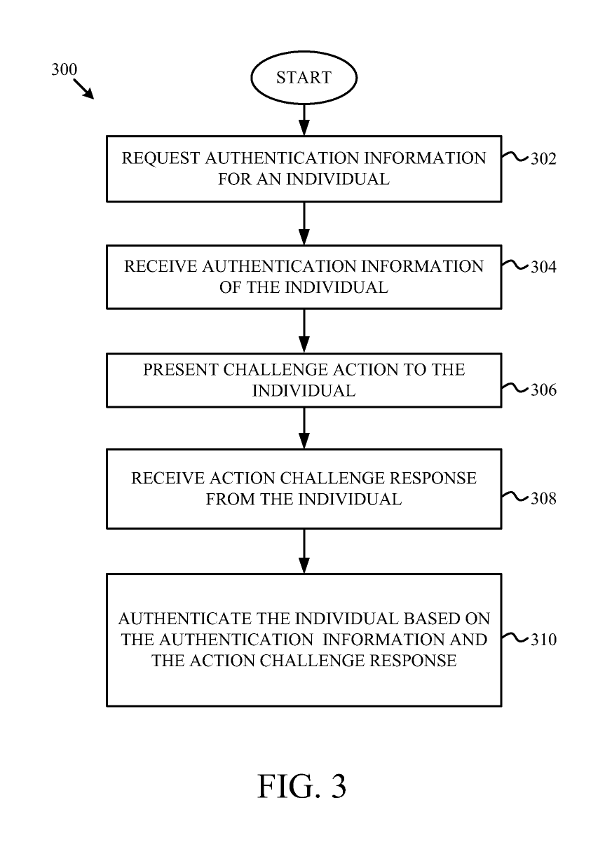

FIG. 3 is a flow chart illustrating an exemplary method 300 for authenticating an individual with an assigned challenge action according to one embodiment of the disclosure. At block 302 authentication information for an individual that is attempting access to secure data or a secure device is requested. The request for authentication information may be presented when a user first activates a device or attempts to exit a lock screen on the device. At block 304 authentication information is received from the individual such as, for example, a fingerprint, an iris image, a picture, and/or a username/password combination.

At block 306 a challenge action is presented to the individual. For example, a prompt may be displayed to the user to “perform the challenge action now.” The challenge action may be one of moving the device in a circle clockwise, moving the device in a circle counter-clockwise, shaking the device, shaking the device with a twisting motion, moving the device in a figure-eight pattern, moving the device back and forth at waist level, and placing the device on top of the individual's head.

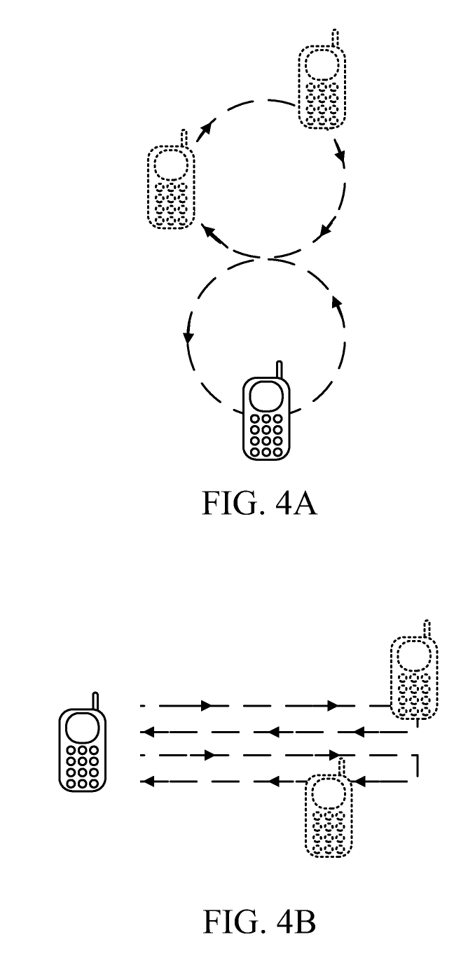

FIGS. 4A-4B are animations illustrating exemplary gesture motions for an action challenge response according to one embodiment of the disclosure. FIG. 4A illustrates an action challenge response in the form of a figure-eight motion. FIG. 4B illustrates an action challenge response in the form of moving the device back and forth at waist level.

Referring back to FIG. 3, each individual may have a custom challenge action for block 306 selected by either the individual or an administrator when the individual's authentication credentials are created. For example, when an individual is first assigned a device, the individual may configure a challenge action that only the individual knows. Additionally, the individual may configure one or more action challenge responses that indicate the individual is under duress. The challenge actions may be used alone for authentication or in addition to authentication information such as a username and password combination. According to one embodiment, the request for the challenge action presented on the device at block 306 does not reveal the specific challenge action for the individual.

At block 308 the action challenge response is received from the individual. The response may be received through a sensor, such as a still camera, a motion camera, a microphone, an accelerometer, and/or a gyroscope. The action challenge response may be recorded by an accelerometer to determine the motion of the device. In another example, the motion of the device may be determined by recording a video from the motion camera, capturing a series of still pictures from the still camera, or measuring the Doppler shift of sounds captured through the microphone.

According to one embodiment, the action challenge response may be a combination of responses or a series of responses of the same type. For example, the user may be requested to repeat the challenge action a number of times. The number of repeats may be assigned to the individual just as the challenge action or the number of repeats may be randomly selected when the challenge action is requested at block 306.

At block 310 the individual is authenticated based, in part, on the authentication information and the action challenge response. According to one embodiment, the authentication may also be based on location information available from, for example, a global positioning system (GPS) receiver. When the individual is authenticated the individual is granted access to the secure data or the device. When authentication of the individual fails an error may be reported to the individual, and the individual may be prompted to attempt authentication again.

The authentication may be performed locally on the device accessed by the individual. The authentication may also be performed remotely on a server in communication with the device. For example, if the device is a mobile device such as, for example, a laptop computer or a mobile phone, hardware on the mobile device may record the authentication information and the action challenge response and transmit the information and response to a server. The server processes the information and response to generate an authentication message transmitted to the mobile device. The authentication message instructs the mobile device to allow or disallow access to secure data or the device by the individual.

Thus, the authentication process may include steps performed by an authentication server and a client device. According to one embodiment, the steps for authentication on the client device may be integrated into a client plug-in for access on the client device. The plug-in allows applications from different manufacturers executing on the device to perform authentication through the plug-in allowing a single authentication server to allow or disallow access to different types of secure data. The plug-in may be used to perform authentication for access to data such as, for example, bank data.

A bank may provide a mobile application to allow a customer through a mobile phone to access bank account information such as balances and to perform money transfers. The combination of the authentication information and the action challenge response ensures that the individual accessing the secure data or the device was present at the mobile device and reduces the likelihood of or prevents an imposter from gaining access to the secure data or the device.

Referring back to FIG. 2, when a challenge action is performed at block 204 as part of the confirmation response duress responses may be defined by the individual's response to the challenge action. For example, if the challenge action is a “wink,” a left-eye wink may be a normal confirmation response, and a right-eye wink may be a duress response. In another example, if the challenge action is “perform your gesture,” a bowling motion may be a normal confirmation response and a shaking motion may be a duress response. In yet another example, if the challenge action is “say your pas phrase,” speaking “cows graze at midnight” may be a normal confirmation response, and “please let me in” may be a duress response. In a further example, saying “trajectory” with eyes closed and finger on the tip of the individual's nose may be a normal confirmation response, and saying “trajectory” with eyes open and no hand near the face may be a duress response.

According to one embodiment, duress responses provided to the device during a confirmation response at block 204 may inform the device of different levels of duress resulting in different actions taken by the device. For example, one duress response may signal an immediate life threat that causes the device to report information to local law enforcement, and a different duress response may only cause the device to deny access to the account.

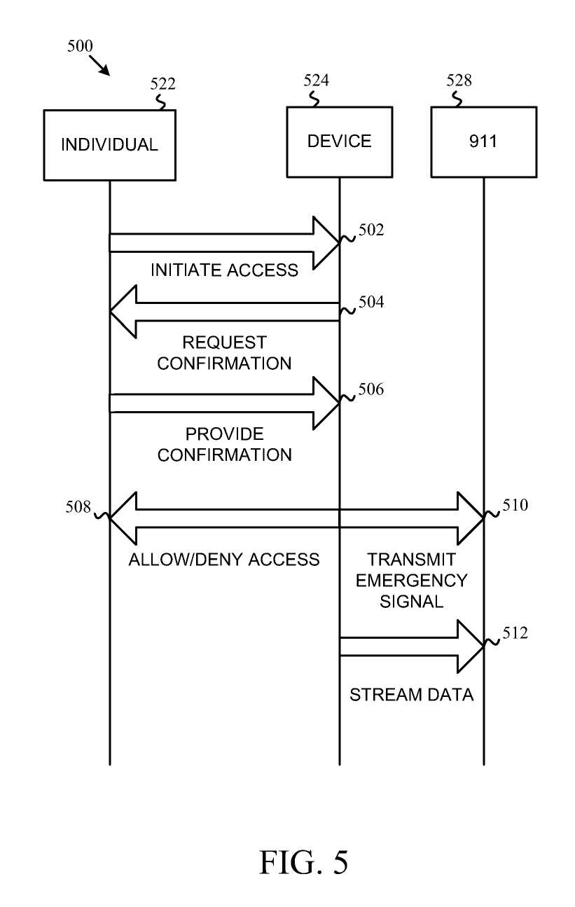

FIG. 5 is a call diagram illustrating activation of a silent alarm according to one embodiment of the disclosure. A call diagram 500 includes calls between an individual 522, a device 524, and an emergency service 528. At call 502 the individual initiates access to the device 524. At call 504 the device 524 requests confirmation of the identity of the individual 522. At call 506 the individual 522 provides a confirmation response. The confirmation response may indicate a duress condition, such as when the individual 522 is being forced to provide the confirmation at call 506 against the will of the individual. When the device 524 recognizes the duress response at call 506, an emergency signal is transmitted to the emergency service 528 at call 510. The emergency signal may be, for example, a secret call to 911 playing an automatically-generated speech file, a text message to 911, or another notification message to law enforcement officials. The device 524 may then allow or deny access to the device 524 by the individual 522 at call 508.

The emergency signal transmitted at call 510 may be one of many different signals. According to one embodiment, the device 524 may transmit the location (e.g., latitude and longitude) of the device 524 obtained from a global positioning system (GPS). According to another embodiment, the device 524 may turn on a camera and record video, which may be streamed to the emergency service 528 through the emergency signal at call 510. According to yet another embodiment, the device 524 may turn on a microphone and record audio, which may be streamed to the emergency service 528 at call 512. According to a further embodiment, the device 524 may increase and decrease or pulse on and off the signal strength of the device 524 to aid in locating the device 524 through triangulation via cell phone towers.

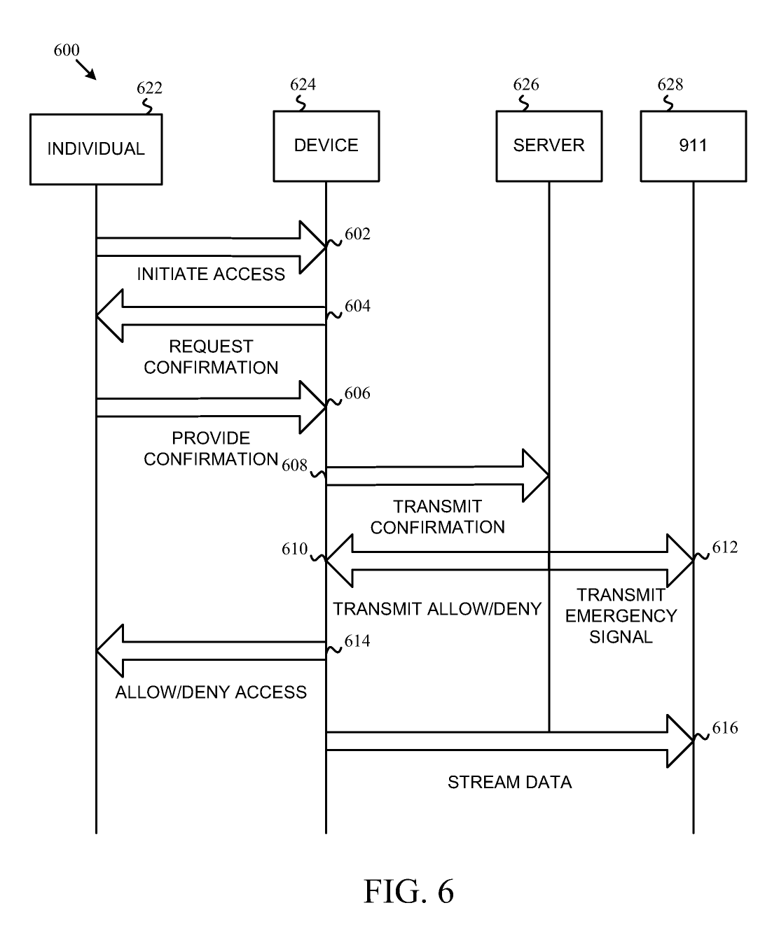

According to one embodiment, a device may pass the confirmation response to a server for server-based authentication, in which the server detects the duress signal and executes a command. FIG. 6 is a call diagram illustrating activation of a silent alarm through a server-based authentication system according to one embodiment of the disclosure. A call diagram 600 includes calls between an individual 622, a device 624, a server 626, and an emergency service 628. At call 602 the individual 622 initiates access to the device 624. At call 604 the device 624 requests confirmation of the identity of the individual 622. At call 606 the individual 622 provides a confirmation response, such as authentication information and/or an action challenge response. At call 608 the confirmation response is transmitted from the device 624 to the server 626. The server 626 responds at call 610 with an authentication response indicating to allow or deny access to the device 624 by the individual 622. When the server 626 recognizes a duress response in the confirmation response of the call 608, the server 626 transmits an emergency signal to the emergency service 628 at call 612. The device 624 allows access by the individual 622 at call 614 based, in part, on the authentication response received from the server 626 at the call 610.

The server 626 may be configured to generate the emergency signal at call 612 and the authentication response at call 610 in a number of ways. According to one embodiment, the device 624 may stream location information, video, and/or audio at call 616 as described above with reference to FIG. 5. Although shown as streaming from the device 624 to the emergency service 628, the device 624 may also stream data to the server 626 for forwarding to the emergency service 628. The emergency signal may also include data such as a photograph, voice print, fingerprint, and/or other distinguishing characteristics of the individual 622. The authentication response at call 610 may also include instructions to the device 624 to restrict some access to the device 629 and/or include dummy data for display by the device 624.

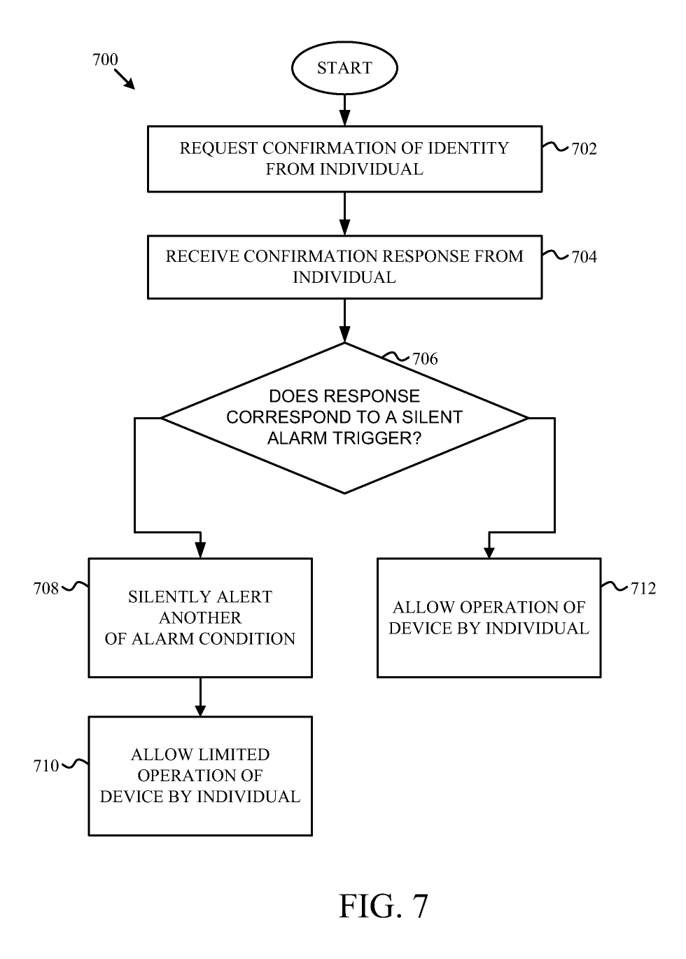

According to one embodiment, a device may be configured to only allow limited operation when a duress response is detected during identity confirmation. FIG. 7 is a flow chart illustrating an exemplary method for allowing limited operation of a device in response to a silent alarm according to one embodiment of the disclosure. A method 700 begins at block 702 with requesting confirmation of identity from an individual. At block 704 the confirmation response is received from the individual. At block 706 it is determined whether the confirmation response corresponds to a silent alarm trigger. If the response does correspond to a silent alarm trigger then the method 700 continues to block 708 to silently alert another of the alarm condition and then to block 710 to allow limited operation of the device by the individual.

The limited access may, for example, prevent the individual from having super-user or administrator access to the device. In another example, the limited operation mode may limit bank transfers to a maximum value, such as $100. Thus, an offender forcing the individual to make a transfer under duress may believe the device is operating normally without being aware of the silent alarm. When the response does not correspond to a silent alarm trigger at block 706, the method 700 continues to block 712 to allow normal operation of the device by the individual.

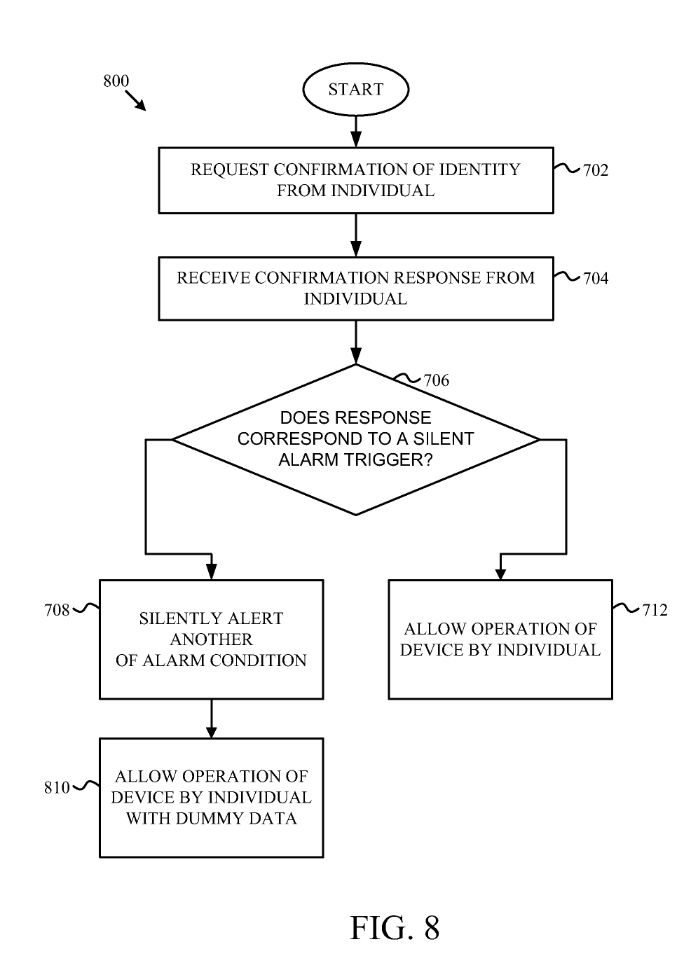

According to another embodiment, a device may be configured to operate with dummy data when a duress response is detected during identity confirmation. FIG. 8 is a flow chart illustrating an exemplary method for presenting dummy data on a device in response to a silent alarm according to one embodiment of the disclosure. A method 800 is similar to the method 700. After silently alerting another at block 708, the method 800 proceeds to block 810 to allow operation of the device by the individual with dummy data.

For example, the device may display dummy bank accounts with fake balances to allow the individual to enter transfers that appear successful to the offender, but are actually fake. According to one embodiment, the dummy data may include an indicator to the individual that informs them that law enforcement officials or others have been alerted to their position. For example, the device may display a balance of “$543.11” to indicate to the individual that police have been notified. To the offender the balance appears legitimate, and the offender is unaware that police have been notified.

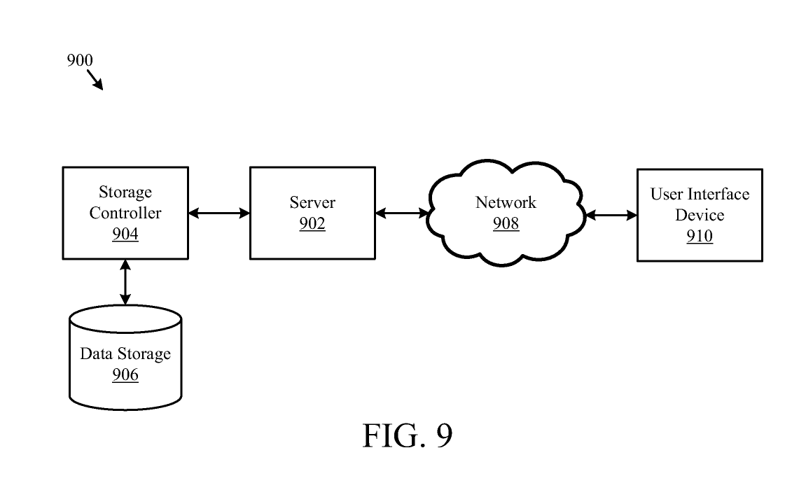

FIG. 9 illustrates one embodiment of a system 900 for an information system, such as a system for authenticating user interface devices such as mobile devices. The system 900 may include a server 902, a data storage device 906, a network 908, and a user interface device 910. The server 902 may be a dedicated server or one server in a cloud computing system. In a further embodiment, the system 900 may include a storage controller 904, or storage server configured to manage data communications between the data storage device 906 and the server 902 or other components in communication with the network 908. In an alternative embodiment, the storage controller 904 may be coupled to the network 908.

In one embodiment, the user interface device 910 is referred to broadly and is intended to encompass a suitable processor-based device such as a desktop computer, a laptop computer, a personal digital assistant (PDA) or tablet computer, a smartphone or other a mobile communication device having access to the network 908. When the device 910 is a mobile device, sensors (not shown), such as a camera, microphone, or accelerometer, may be embedded in the device 910. When the device 910 is a desktop computer the sensors may be embedded in an attachment (not shown) to the device 910. In a further embodiment, the user interface device 910 may access the Internet or other wide area or local area network to access a web application or web service hosted by the server 902 and provide a user interface for enabling a user to enter or receive information.

The network 908 may facilitate communications of data, such as authentication information, between the server 902 and the user interface device 910. The network 908 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the user interface device 910 accesses the server 902 through an intermediate sever (not shown). For example, in a cloud application the user interface device 910 may access an application server. The application server fulfills requests from the user interface device 910 by accessing a database management system (DBMS), which stores authentication information and associated challenge actions. In this embodiment, the user interface device 910 may be a computer or phone executing a Java application making requests to a JBOSS server executing on a Linux server, which fulfills the requests by accessing a relational database management system (RDMS) on a mainframe server.

In one embodiment, the server 902 is configured to store databases, pages, tables, and/or records having authentication information such as duress responses. Additionally, scripts on the server 902 may access data stored in the data storage device 906 via a storage area network (SAN) connection, a LAN, or a data bus. The data storage device 906 may include, for example, a hard disk, including hard disks arranged in a redundant array of independent disks (RAID) array, a tape storage drive comprising a physical or virtual magnetic tape data storage device, or an optical storage device. The data may be arranged in a database and accessible through structured query language (SQL) queries, or other data base query languages or operations.

In another embodiment, the server 902 may be executing on the user interface device 910 in a process or thread. For example, the server 902 may be an SQLite database server executing on a mobile device. The SQLite database may include configuration information, authentication information, and/or other user data.

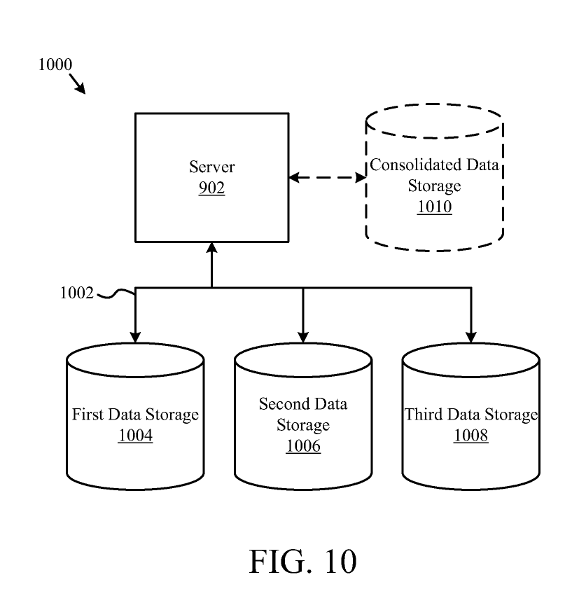

FIG. 10 illustrates one embodiment of a data management system 1000 configured to store authentication information. In one embodiment, the data management system 1000 may include the server 902. The server 902 may be coupled to a data-bus 1002. In one embodiment, the data management system 1000 may also include a first data storage device 1004, a second data storage device 1006, and/or a third data storage device 1008. In further embodiments, the data management system 1000 may include additional data storage devices (not shown). In such an embodiment, each data storage device 1004, 1006, and 1008 may each host a separate database that may, in conjunction with the other databases, contain redundant data. Alternatively, a database may be spread across storage devices 1004, 1006, and 1008 using database partitioning or some other mechanism. Alternatively, the storage devices 1004, 1006, and 1008 may be arranged in a RAID configuration for storing a database or databases that may contain redundant data. Data may be stored in the storage devices 1004, 1006, 1008, and 1010 in a database management system (DBMS), a relational database management system (RDMS), an object oriented database management system (OODMS), an indexed sequential access method (ISAM) database, a multi-sequential access method (MSAM) database, a conference on data systems languages (CODASYL) database, or other database system.

In one embodiment, the server 902 may submit a query to select data from the storage devices 1004 and 1006. The server 902 may store consolidated data sets in a consolidated data storage device 1010. In such an embodiment, the server 902 may refer back to the consolidated data storage device 1010 to obtain a set of records. Alternatively, the server 902 may query each of the data storage devices 1004, 1006, and 1008 independently or in a distributed query to obtain the set of data elements. In another alternative embodiment, multiple databases may be stored on a single consolidated data storage device 1010.

In various embodiments, the server 902 may communicate with the data storage devices 1004, 1006, and 1008 over the data-bus 1002. The data-bus 1002 may comprise a storage area network (SAN), a local area network (LAN), or the like. The communication infrastructure may include Ethernet, fibre-channel arbitrated loop (FC-AL), fibre-channel over Ethernet (FCoE), small computer system interface (SCSI), internet small computer system interface (iSCSI), serial advanced technology attachment (SATA), advanced technology attachment (ATA), cloud attached storage, and/or other similar data communication schemes associated with data storage and communication. For example, the server 902 may communicate indirectly with the data storage devices 1004, 1006, 1008, and 1010 by first communicating with a storage server (not shown) or the storage controller 904.

The server 902 may include modules for interfacing with the data storage devices 1004, 1006, 1008, and 1010, may include modules for interfacing with the network 908, and/or modules for interfacing with a user through the user interface device 910. In a further embodiment, the server 902 may host an engine, application plug-in, or application programming interface (API).

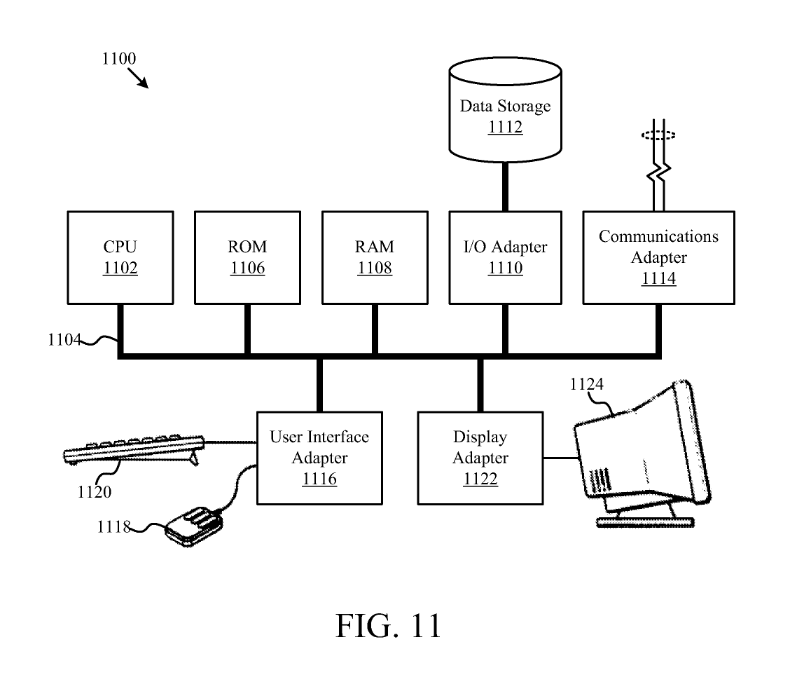

FIG. 11 illustrates a computer system 1100 adapted according to certain embodiments of the server 902 and/or the user interface device 910. The central processing unit (“CPU”) 1102 is coupled to the system bus 1104. The CPU 1102 may be a general purpose CPU or microprocessor, graphics processing unit (“GPU”), and/or microcontroller. The present embodiments are not restricted by the architecture of the CPU 1102 so long as the CPU 1102, whether directly or indirectly, supports the modules and operations as described herein. The CPU 1102 may execute the various logical instructions according to the present embodiments.

The computer system 1100 also may include random access memory (RAM) 1108, which may be synchronous RAM (SRAM), dynamic RAM (DRAM), and/or synchronous dynamic RAM (SDRAM). The computer system 1100 may utilize RAM 1108 to store the various data structures used by a software application such as databases, tables, and/or records. The computer system 1100 may also include read only memory (ROM) 1106 which may be PROM, EPROM, EEPROM, optical storage, or the like. The ROM may store configuration information for booting the computer system 1100. The RAM 1108 and the ROM 1106 hold user and system data.

The computer system 1100 may also include an input/output (I/O) adapter 1110, a communications adapter 1114, a user interface adapter 1116, and a display adapter 1122. The I/O adapter 1110 and/or the user interface adapter 1116 may, in certain embodiments, enable a user to interact with the computer system 1100. In a further embodiment, the display adapter 1122 may display a graphical user interface (GUI) associated with a software or web-based application on a display device 1124, such as a monitor or touch screen.

The I/O adapter 1110 may couple one or more storage devices 1112, such as one or more of a hard drive, a flash drive, a compact disc (CD) drive, a floppy disk drive, and a tape drive, to the computer system 1100. The communications adapter 1114 may be adapted to couple the computer system 1100 to the network 908, which may be one or more of a LAN, WAN, and/or the Internet. The communications adapter 1114 may also be adapted to couple the computer system 1100 to other networks such as a global positioning system (GPS) or a Bluetooth network. The user interface adapter 1116 couples user input devices, such as a keyboard 1120, a pointing device 1118, and/or a touch screen (not shown) to the computer system 1100. The keyboard 1120 may be an on-screen keyboard displayed on a touch panel. Additional devices (not shown) such as a camera, microphone, video camera, accelerometer, compass, and or a gyroscope may be coupled to the user interface adapter 1116. The display adapter 1122 may be driven by the CPU 1102 to control the display on the display device 1124.

The applications of the present disclosure are not limited to the architecture of computer system 1100. Rather the computer system 1100 is provided as an example of one type of computing device that may be adapted to perform the functions of a server 902 and/or the user interface device 910. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. For example, although devices such as mobile devices are described, the embodiments may be implemented on fixed location devices such as automatic teller machines (ATMs). As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. For example, the embodiments may be applied to devices accessible through another device, such as when a door lock is unlocked by confirming the identity of an individual through a mobile device. Short range communications such as this may be accomplished through near field communications (NFC) or later developed technologies. Accordingly, the appended claims are intended to include within their scope such processes, machines, manufacture, compositions of matter, means, methods, or steps.

What is claimed is:

1. A method, comprising:
requesting confirmation of an identity from an individual;
receiving identity confirmation from the individual;
determining whether the identity confirmation corresponds to a command; and
executing the command when the identity confirmation corresponds to the command.

2. The method of claim 1, in which receiving the identity confirmation comprises receiving authentication information and an action challenge response.

3. The method of claim 2, in which the command comprises changing the authentication information.

4. The method of claim 3, in which the command comprises changing a password.

5. The method of claim 4, in which the step of changing the password comprises changing the password to a secondary password previously-selected by the individual.

6. The method of claim 1, in which the command comprises displaying a particular display to the individual.

7. The method of claim 1, in which the confirmation is requested when the individual attempts to access secure data on a mobile device.

8. A computer program product, comprising:
a non-transitory computer readable medium comprising:
code to request confirmation of an identity from an individual;
code to receive identity confirmation from the individual;
code to determine whether the identity confirmation corresponds to a command; and
code to execute the command when the identity confirmation corresponds to the command.

9. The computer program product of claim 8, in which receiving the identity confirmation comprises receiving authentication information and an action challenge response.

10. The computer program product of claim 9, in which the command comprises changing the authentication information.

11. The computer program product of claim 10, in which the command comprises changing a password.

12. The computer program product of claim 11, in which the step of changing the password comprises changing the password to a secondary password previously-selected by the individual.

13. The computer program product of claim 8, in which the command comprises displaying a particular display to the individual.

14. The computer program product of claim 8, in which the confirmation is requested when the individual attempts to access secure data on a mobile device.

15. An apparatus, comprising:
a memory; and
at least one processor coupled to the memory, in which the at least one processor is configured:
to request confirmation of an identity from an individual;
to receive identity confirmation from the individual;
to determine whether the identity confirmation corresponds to a command; and
to execute the command when the identity confirmation corresponds to the command.

16. The apparatus of claim 15, further comprising:
a keypad coupled to the at least one processor; and
an accelerometer coupled to the at least one processor, in which the at least one processor is further configured:
to receive authentication information from the individual through the keypad; and
to receive an action challenge response from the individual through the accelerometer.

17. The apparatus of claim 16, in which the action challenge response corresponds to a command to change authentication information.

18. The apparatus of claim 17, in which the at least one processor is further configured to change authentication information for the individual to secondary authentication information.

19. The apparatus of claim 18, in which the authentication information comprises a password.

20. The apparatus of claim 15, in which the at least one processor is configured to request confirmation when the individual attempts to access secure data on a mobile device.
